(19) United States
(12) Patent Application Publication
(10) Pub. No.: US 2012/0050025 A1
(43) Pub. Date: Mar. 1, 2012

(54) VEHICLE STEERING ASSIST SYSTEM AND METHOD OF OPERATION

(76) Inventor: James J. Hoeffel, Lake Orion, MI (US)

(21) Appl. No.: 12/868,774

(22) Filed: Aug. 26, 2010

(51) Int. Cl. B60Q 1/00

(52) U.S. Cl. 340/435

(57) ABSTRACT

A steering assist system for a vehicle is provided. The steering assist system includes a steering angle sensor that detects an angular position of a steering wheel. The system also includes one or more first sensors that scan a first area for objects. The first area includes at least a portion of a first zone and at least a portion of a second zone. The first zone is behind or in front of the vehicle and extends substantially the width of the vehicle. The second zone is adjacent to the first zone and extends along a first side of the vehicle and extends in an outward vehicle lengthwise direction from a corner of the vehicle. The system also includes a control module that switches between a first mode and a second mode based on the angular position of the steering wheel. At the first mode the one or more first sensors are utilized to detect objects in at least the portion of the first zone and not in the second zone. At the second mode at least one of the one or more first sensors is utilized to detect objects in the first area.

### FIELD

The present disclosure relates to sensor systems and more particularly to sensing systems for vehicles.

### BACKGROUND

Drivers are often required to exercise judgment in the maneuvering of vehicles with respect to other objects near the vehicle that may be stationary or in motion. Such objects may be street signs, pedestrians, animals, other vehicles, curbs, parking structures, a shopping cart, and/or other inanimate objects. This is particularly apparent, for example, when a vehicle operator is negotiating a parking space, maneuvering in a driveway, or other situations where objects close to the vehicle are not readily visible to the operator during vehicle operation. Although the use of vehicle mirrors can assist, there still may be nearby areas not visible to the vehicle operator, whereby the operator may benefit from the judicious notification of detected objects proximate the vehicle.

### SUMMARY

A steering assist system for a vehicle comprises a steering angle sensor that detects an angular position of a steering wheel. The system also comprises one or more first sensors that scan a first area for objects. The first area includes at least a portion of a first zone and at least a portion of a second zone. The first zone is behind or in front of the vehicle and extends substantially the width of the vehicle. The second zone is adjacent to the first zone and extends along a first side of the vehicle and extends in an outward vehicle lengthwise direction from a corner of the vehicle. The system also comprises a control module that switches between a first mode and a second mode based on the angular position of the steering wheel. At the first mode the one or more first sensors are utilized to detect objects in at least the portion of the first zone and not in the second zone. At the second mode at least one of the one or more first sensors is utilized to detect objects in the first area.

In other features, the control module switches from the first mode to the second mode when the angular position of the steering wheel is greater than a predetermined threshold. The system further comprises one or more second sensors that scan a second area. The second area includes at least a portion of a third zone and at least a portion of a forth zone. The third zone is either behind or in front of the vehicle and extends substantially the width of the vehicle. The forth zone is adjacent the third zone and extends along a second side of the vehicle and extends in an outward vehicle lengthwise direction from a corner of the vehicle. At the first or third modes the system does not generate a signal to notify the vehicle operator of objects detected in the forth zone.

In other features, a method for operating a steering assist system for a vehicle comprises detecting an angular position of a steering wheel, utilizing a steering angle sensor. The method also comprises scanning a first area for objects utilizing one or more first sensors. The first area includes at least a portion of a first zone and at least a portion of a second zone. The first zone is behind or in front of the vehicle and extends substantially the width of the vehicle. The second zone is adjacent to the first zone and extends along a first side of the vehicle and extends in an outward vehicle lengthwise direction from a corner of the vehicle. The method also comprises switching between a first mode and a second mode based on the angular position of the steering wheel utilizing a control module. At the first mode the one or more first sensors are utilized to detect objects in at least the portion of the first zone and not in the second zone. At the second mode at least one of the one or more first sensors is utilized to detect objects in the first area.

In other features, a vehicle system for a vehicle comprises a steering angle sensor that senses an angle of a steering wheel. The system also comprises one or more first sensors. The one or more first sensors sense a first area behind the vehicle. The first area comprises at least part of a first zone and at least part of a second zone. The first zone is directly behind the vehicle. The second zone is adjacent to the first zone and is at least one of at a side of or at a corner of the vehicle. The system also comprises a control module that switches between a first mode and a second mode based on the angle of the steering wheel. The first mode includes detection of objects in the first zone and not the second zone. The second mode includes detection of objects in both the first zone and the second zone.

In other features the vehicle system further comprises one or more second sensors. The one or more second sensors sense a second area. The second area comprises at least part of a third zone and at least part of a fourth zone. The third zone is directly in front of the vehicle. The fourth zone is adjacent to the third zone.

### BRIEF DESCRIPTION OF THE DRAWINGS

The present invention will become more fully understood from the detailed description and the accompanying drawings, wherein:

FIGS. 1-3 are partial schematic diagrams of a vehicle steering assist system utilized with a vehicle, according to the present disclosure;

FIG. 4 is a block diagram of a vehicle steering assist system, according to the present disclosure; and

FIG. 5 is a logic flow diagram that illustrates operation of a vehicle steering assist system, according to the present disclosure.

### DETAILED DESCRIPTION

As used herein, the term module refers to components, devices and systems that are electric and/or mechanical that provides signals, instructions, and/or activate other vehicle components and systems. Modules can include all those functions listed above. Further, a module may be an Application Specific Integrated Circuit (ASIC), an electronic circuit, a processor (shared, dedicated, or group) and memory that execute one or more software or firmware programs, a combinational logic circuit, and/or other suitable components that provide the described functionality.

The present disclosure relates to a vehicle steering assist system that includes driving and/or park assist features. The driving and/or park assist features may be activated when the vehicle is stationary or is driving at slow speeds, such as when the vehicle is negotiating tight spaces, driveways, parking structures, or making turns, while moving forward or reverse. The driving and/or park assist features may also or alternatively be activated by a vehicle operator. The steering assist system includes sensors positioned proximate the front, rear, corners and/or sides of a vehicle. The front and rear sensors scan areas/zones for objects near the front and rear of the vehicle. The steering assist system may also or alternatively include corner and side sensors that scan areas/zones for objects near the corners and sides of the vehicle instead of or in addition to the zones in the front and rear of the vehicle. The zones may be a predetermined size so that the sensors detect objects within a predetermined distance from the vehicle. For example, the sensors may detect objects within 6 ft, 3 ft or 1 ft of the vehicle.

One or more of the sensors is active when the vehicle is in motion or placed in an operational position for motion, such as a shifter being moved from park to another gear, neutral, and reverse. The steering assist system may send a warning to the vehicle operator when an object is detected by one or more of the sensors when the vehicle is placed in an operational position for motion. The vehicle is considered in motion while moving forward, rearward, turning, when in first gear, second gear, third gear, etc. in reverse, or in neutral. In one embodiment the vehicle system sends the warning to the vehicle operator of a detected object when the vehicle is stationary or in motion at or below a predetermined speed, such as 10 mph, 5 mph, etc. The vehicle system sends the warning to the vehicle operator of a detected object when the vehicle is stationary or when the vehicle is placed in an operational position for motion and the vehicle is not actually moving, i.e. before the vehicle begins movement.

In one embodiment, the steering assist system includes sensors positioned proximate the sides, corners, rear and/or front of the vehicle that provide respective fields of view of the area behind of the vehicle, the areas near the sides or corners of the vehicle and/or the area in front of the vehicle. When the steering wheel of the vehicle is positioned so that the vehicle wheels are not turned to thereby move the vehicle along a substantially straight path either forward or rearward, the steering assist system responds to a first area within the field(s) of view provided by the sensors. When the steering wheel is turned (i.e., the vehicle wheels are turned), the vehicle system responds to a second area within the field(s) of view provided by the sensors. The second area covers areas to the sides of the vehicle and/or areas extending from the vehicle corners. The first area covers areas directly behind or directly in front of the vehicle and does not cover areas to the sides of the vehicle or areas extending from the vehicle corners. The system is configured so the operator is not notified of objects detected in areas other than directly behind or in front of the vehicle when the vehicle is in an operational position for motion along a substantially straight path either in a rearward or forward direction.

Referring now to FIGS. 1 and 2, one embodiment of a vehicle steering assist system 10 includes a control module 12 that receives signals from one or more sensors that are positioned on a vehicle 13. Sensors are positioned relative to the rear areas of the vehicle 13, such as sensors 11, 14, 15, 16, 17, 18 as illustrated, although various numbers of sensors may be used. Sensors are positioned relative to the front areas of the vehicle 13, such as sensors 30, 32, 33, 34, 36, 38 as illustrated, although various numbers of sensors may be used. Numerous other locations for the sensors at or near the rear and at or near the front of the vehicle 13 may also be used.

Sensors 11, 14, 15, 16, 17, and 18 are positioned proximate the rear portion of the vehicle and are configured to detect objects in areas 42, 41, 44, 43, 45, and 47, respectively. Areas 41, 42, 43, 44, 45, and 47 are illustrated as cone shaped areas, but the respective sensors can be configured to detect objects in other shaped areas. Sensors 30, 32, 33, 34, 36, and 38 are positioned proximate the front portion of the vehicle and are configured to detect objects in cone shaped areas 60, 62, 64, 66, 68, and 70, respectively, but the respective sensors can be configured to detect objects in other shaped areas. The vehicle 13 includes front wheels 22, 24 and one or more steering wheel sensors 26 that detect an absolute steering angle of the steering wheel 25 relative to the vehicle's wheels 22, 24 straight position.

In an exemplary configuration of the steering assist system 10, a mode select module 20 receives signals indicative of the vehicle placed in a position for motion in a forward or rearward direction and whether the vehicle is moving in a straight or turning manner. Based on those signals, the mode select module 20 then selects a mode to activate certain sensors. If the activated sensors detect an object within their area, then notification is provided to the vehicle operator of the detected object. For example, mode 1 is selected to correspond to vehicle motion in a rearward direction and in a substantially straight manner with certain sensors activated to detect objects in an area directly behind the vehicle. The area directly behind the vehicle here is considered the first area or first zone. Mode 2 is selected to correspond to vehicle motion in a rearward direction and in a turning manner with certain sensors activated to detect objects in an area directly behind the vehicle and within certain side and corner areas of the vehicle. Mode 3 is selected to correspond to vehicle motion in a forward direction and in a substantially straight manner with certain sensors activated to detect objects in an area directly in front of the vehicle. Mode 4 is selected to correspond to vehicle motion in a forward direction and in a turning manner with certain sensors activated to detect objects in an area directly in front of the vehicle and within certain side and corner areas of the vehicle. The vehicle motion could be when the vehicle is operated in, or initially placed in, drive, a gear, reverse, and neutral.

In one embodiment, the mode select module 20 of the control module 12 receives signals from the steering angle sensor 26 and switches between modes based on the signals and/or based on whether the vehicle 13 is moving. In one embodiment, the vehicle steering assist system 10 is configured to operate to notify the operator of a detected object when the vehicle is stationary or moving below a predetermined speed threshold. In an alternative embodiment, the steering assist system 10 is configured to operate to notify the operator of a detected object when the vehicle is moving, or about to move, and the operator initiates operation of the steering assist system. For example, in one embodiment, the mode select module 20 and/or the entire steering assist system 10 is not activated unless the vehicle 13 is moving slower than a predetermined speed, such as 10 mph, 5 mph, etc The mode select module 20 may also receive a signal from a transmission control module 27 indicative of the motion of vehicle 13.

In one embodiment, the mode select module 20 of the control module 12 receives signals from the steering angle sensor 26 and switches between a first mode and a second mode based on the signals when the vehicle 13 is moving, or about to move as when placed in an operational driving position, in a rearward direction (as indicated by arrow 29 as shown in FIGS. 1 and 2).

The mode select module 20 selects the first mode when the wheels 22, 24 are aligned or the steering wheel is not turned so the vehicle 13 moves along a substantially straight path in a rearward direction. The steering wheel 25 is considered not turned when it is turned less than a predetermined steering wheel angle threshold, such as +/−5 degrees or less, as indicated by steering angle signals from sensor 26. In exemplary embodiments, the sensor 26 measures the absolute angle of the steering wheel 25 relative to the vehicle's wheels 22, 24 straight position. In an exemplary embodiment, wheels 22, 24 straight position could be 0 degrees to +/−5 degrees. The predetermined steering wheel angle threshold may also correspond to an amount of steering angle that is greater than +/−5 degrees from the straight position, for example +/−10-20 degrees. A positive angular position can correspond to turning the steering wheel to the right, while a negative angular position can correspond to turning the steering wheel to the left or vice versa.

In the first mode, the vehicle system 10 only responds to objects in a zone 19 directly behind the vehicle 13. The zone 19 is covered by one or more of the sensors 14, 16, 17, 18. Even though the sensors 14, 16, 17, 18 may detect objects in areas not covered in the zone 19, the steering assist system 10 does not respond to them. In another embodiment, the steering assist system 10 may simply turn off sensors that do not cover zone 19.

Referring to FIGS. 1-3, the mode select module 20 selects the second mode when the vehicle is moving, or about to move, rearward and the wheels 22, 24 are turned because the steering wheel 25 is turned by an angular amount greater than the predetermined threshold, as indicated by steering angle signals from sensor 26. For example, if the steering wheel 25 is turned by an amount greater than +/−10 degrees, the mode select module 20 selects the second mode.

In the second mode, the vehicle system 10 responds to objects in zone 19 directly behind the vehicle 13 and also responds to objects detected in side zones 21, 23 on either side of (i.e. adjacent to) the zone 19. In another embodiment, the steering assist system 10 responds to objects detected in zones 19, 21, 23 and 37, where objects may be encountered given the vehicle rearward and turning motion. In another embodiment, the steering assist system 10 responds to objects detected in zones 19, 21, 23, 37 and 39. The zone 19 and the side zones 21, 23 may include most or all of the areas detected by the respective sensors 11, 14, 15, 16, 17, 18.

The zone 19 and the side zones 21, 23 may also include predefined areas of interest within the fields of view of the sensors 11, 14, 15, 16, 17, 18. The areas of interest may extend a predetermined distance from the vehicle 13, such as 6 ft, 3 ft or 1 ft from the vehicle 13. For example, sensors 15, 17 and 18 may be configured to detect object 31 in zone 23, shown in FIG. 2.

Another embodiment of the vehicle system 10 includes one or more sensors positioned relative to the front and/or sides of the vehicle 13. Six sensors 30, 32, 33, 34, 36, 38 are illustrated, although various numbers of sensors may be used. For example, a single sensor may be used. In one embodiment, the sensors 30, 34 are positioned on front corners of the vehicle 13, the sensors 36, 38 are positioned on front sides of the vehicle 13, and the sensors 32, 33 are positioned relative to the front of the vehicle 13. Numerous other locations for the sensors at or near the front of the vehicle 13 may also be used. Each sensor 30, 32, 33, 34, 36, 38 senses an area 60, 62, 64, 66, 68, 70 in a respective field of view of the sensor.

The mode select module 20 of the control module 12 receives signals from the steering angle sensor 26 and switches between a third mode and a fourth mode based on the signals and/or based on whether the vehicle 13 is moving, or about to be moved, forward (as indicated by arrow 29). In one embodiment, the control module 12 switches between the third mode and the fourth mode based on the signals when the vehicle 13 is moving, or about to move, forward and the steering wheel angle is indicative of turning.

In one embodiment, the mode select module 20 selects the third mode when the wheels 22, 24 are aligned with the vehicle 13 and the steering wheel is not turned so the vehicle moves along a substantially straight path in a forward direction. The steering wheel 25 is considered not turned when it is turned less than a predetermined threshold, such as +1-5 degrees. The predetermined threshold may also correspond to +1-10 degrees. In the third mode, the vehicle system 10 only detects objects in a zone 35 directly in front of the vehicle 13. The zone 35 is covered by one or more of the sensors 30, 32, 33 and 34. In the third mode, even though the sensors 30, 32, 33 and 34 may detect objects in areas not covered in the zone 35, the vehicle system 10 does not respond to them.

The mode select module 20 selects the fourth mode when the vehicle is moving forward and the wheels 22, 24 turned by an angular amount greater than the predetermined threshold. For example, if the steering wheel 25 is turned by an amount greater than +1-10 degrees, the mode select module 20 selects the fourth mode.

In the fourth mode, the vehicle system 10 detects objects in the zone 35 and also detects objects in side zones 37, 39 on either side of the zone 35. The zone 35 and the side zones 37, 39 may include most or all of the areas detected by the sensors 30, 32, 33, 34, 36, 38 or may include predefined areas of interest. In another embodiment, the steering assist system 10 responds to objects detected in zones 35, 37, 39 and 21, where objects may be encounter given the forward and turning vehicle motion. In another embodiment, the steering assist system 10 responds to objects detected in zones 35, 37, 39, 21 and 23. The sensors 30, 32, 33, 34, 36, 38 may detect objects in the zones, such as the object 51 shown in FIG. 3. The object 51 is illustrated as a parking spot divider or other garage structure; however, numerous other objects may also be detected.

Each of the modes discussed above references a driving condition such as moving, or about to move, forward or rearward while steering in a straight or a turning path. It should be understood that use of first, second, third and forth modes is exemplary only and the steering assist system can engage and respond from any one (first) condition to another (second) condition.

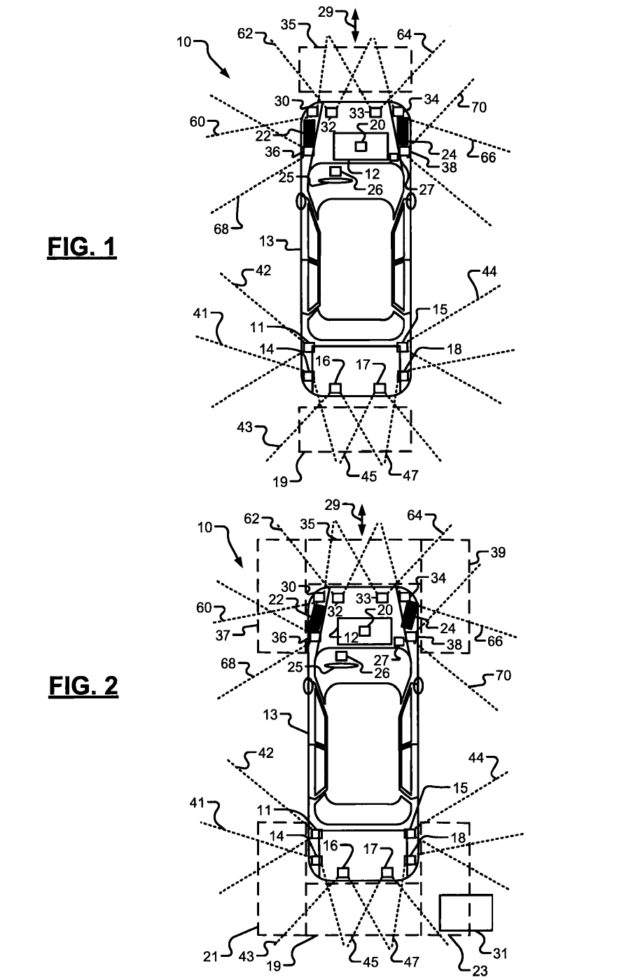

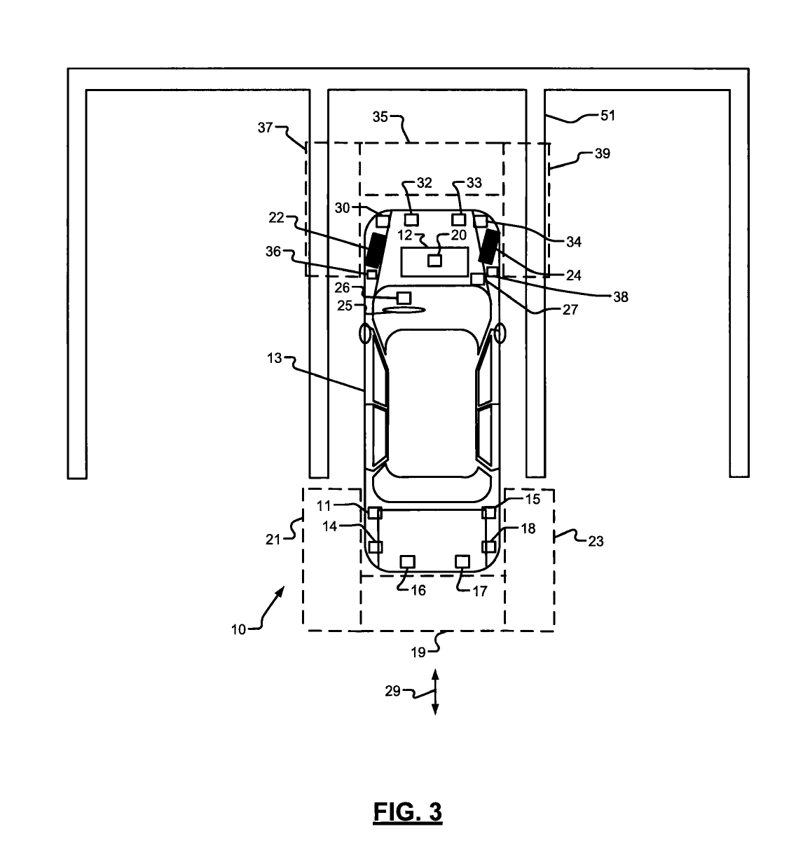

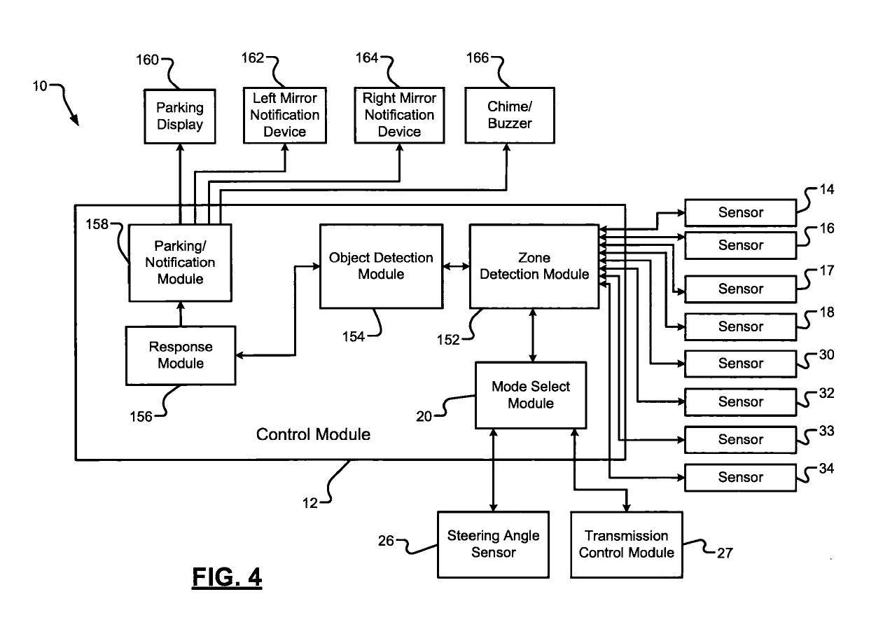

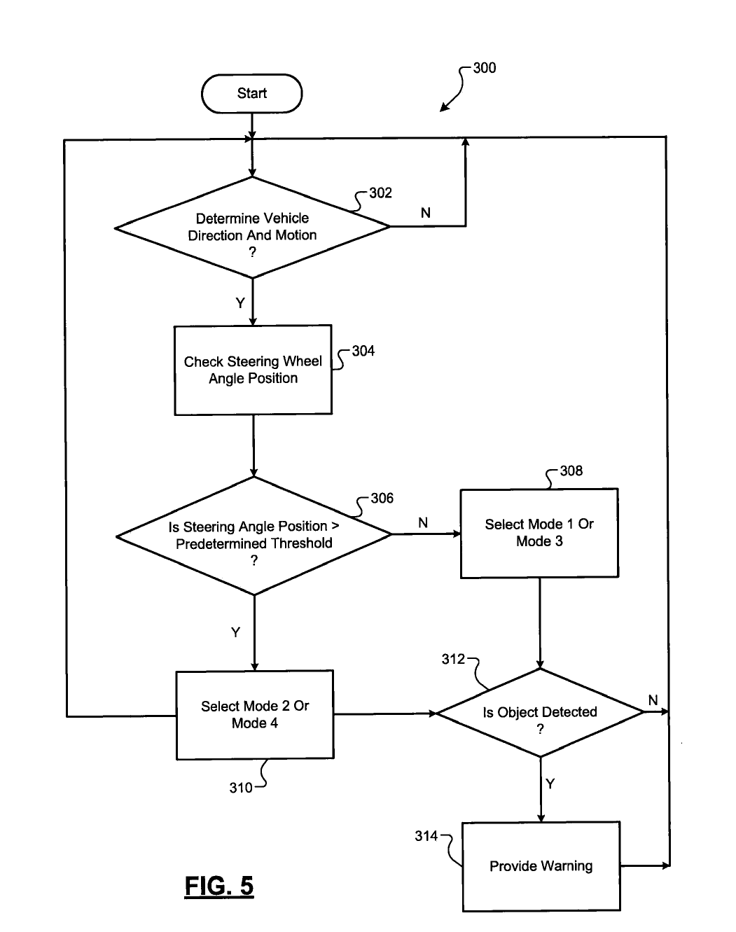

Referring now to FIG. 4, an exemplary embodiment of a vehicle steering assist system 10 is illustrated. The control module 12 includes the mode select module 20, a zone detection module 152, an object detection module 154, a response module 156 and a parking notification module 158. The control module 12 may communicate with the various vehicle sensors through a wired or wireless control area network (CAN) (not shown) of the vehicle 13.

If the vehicle 13 is in reverse, the mode select module 20 selects between the first mode and the second mode. If the vehicle 13 is moving forward, the mode select module 20 selects between the third mode and the fourth mode. The zone detection module 152 detects predetermined zones within the fields of view of the sensors 11, 14, 15, 16, 17, 18 or 30, 32, 33, 34, 36, 38 based on the selected mode (e.g., the zones for the first or third modes, and the zones for the second and fourth modes).

The object detection module 154 detects objects in the predetermined zones near the vehicle 13 based on zone detection module signals. The response module 156 responds to object detection module signals and determines various responses, if any, that the steering assist system will generate based on the object detection module signals. In one embodiment, the response module 156 generates signals that control a parking notification module 158 such that the parking notification module 158 controls audible and/or visual indications to the vehicle operator. Such indications may include a visual display, such as a parking display 160, a left mirror notification device 162, and/or a right mirror notification device 164. The notification devices may display an icon indicating an object near the vehicle 13 in detected zones when the vehicle system 10 is responding to objects in those detected zones. Such indications may also include audible devices, such as chimes or buzzers 166.

The vehicle steering assist system 10 may operate when the vehicle 13 is moving, or about to move, rearward, e.g. reverse, or moving forward. In one embodiment, the system 10 operates only when the vehicle is moving at speeds below a predetermined threshold, such as 10 mph, 5 mph, etc. or when the vehicle operator activates the system 10. The system 10 alerts the operator to objects, such as a human, an animal, a vehicle, a garage structure, a tree, a bicycle, a shopping cart, a fire hydrant, a boulder, a toy, or other inanimate object to be encountered. The system 10 alerts the operator to objects that are directly behind or directly in front of the vehicle 13 when the steering wheel 25 is not rotated or is rotated at a minimal angle below a predetermined threshold. The system 10 alerts the operator to objects that are at the sides or corners of the vehicle 13 when the steering wheel 25 is rotated at an angle above the predetermined threshold.

In one embodiment, left and right mirror notification devices 162, 164 generate icons that appear on side mirrors (not shown) to illustrate a detected object and it proximity. The vehicle 13 may also include the parking display 160 such that there is a redundant/secondary visual indication of an object in a rear cross path of the vehicle 13. A parking display 160, such as a Parksense or a Parktronics visual display, may display a series of light-emitting diodes (LEDs) that indicate to the driver how far the vehicle 13 is to objects from the rear or front bumper. The parking display 160 may also include arrow icons that illustrate which direction the object is in relation to the vehicle 13. The parking display 160 illuminates simultaneously with icons on side mirrors such that the operator may use side mirrors, rear view mirrors, or visual confirmation through glancing back through a rear window to determine object presense/proximity and/or navigate the vehicle 13.

The response module 156 may also trigger the chime 166 to indicate a degree of object proximity to the vehicle 13 based on response module signals. During the chime and/or buzzer, the vehicle 13 may provide a tone from either or both the chime 166 and the parking display 160.

Referring now to FIG. 5, a logic flow diagram 300 illustrating a method for operating the steering assist system 10 starts by determining that the vehicle 13 is moving, or about to move, forward or rearward and at what speed in step 302. The mode select module 20 makes this determination based on, for example, signals from the transmission control module 27 and/or signals from a speedometer. If the vehicle 13 is moving less than a predetermined threshold, such as 10 mph, 5 mph, etc. then control moves to step 304. In step 304, the mode select module 20 checks the steering wheel angle position compared to a straight path reference. In step 306, the mode select module 20 determines whether the steering wheel 25 is straight or rotated within a predetermined threshold, such as +/−5 degrees, based on steering angle sensor signals. If the steering wheel 25 is not rotated, the mode select module 20 selects the first mode if moving in reverse or the third mode if moving forward in step 308. If the steering wheel 25 is rotated, the mode select module 20 selects the second mode if moving in reverse and/or the fourth mode if moving forward in step 310. In step 312, if an object is detected in any of modes 1-4, the vehicle system 10 may provide a warning to the vehicle operator in step 314. Otherwise, control returns to step 302.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A steering assist system for a vehicle comprising:
a steering angle sensor that detects an angular position of a steering wheel;
one or more first sensors that scan a first area for objects, the first area includes at least a portion of a first zone and at least a portion of a second zone, the first zone behind or in front of the vehicle and extending substantially the width of the vehicle, the second zone adjacent to the first zone, the second zone extending along a first side of the vehicle and extending in an outward vehicle lengthwise direction from a corner of the vehicle; and
a control module that switches between a first mode and a second mode based on the angular position of the steering wheel, wherein at the first mode the one or more first sensors are utilized to detect objects in at least the portion of the first zone and not in the second zone, and wherein at the second mode at least one of the one or more first sensors is utilized to detect objects in the first area.

2. The steering assist system of claim 1, wherein the control module switches from the first mode to the second mode when the angular position of the steering wheel is greater than a predetermined threshold.

3. The steering assist system of claim 2, wherein the predetermined threshold is one of +1-5 degrees, +1-10 degrees, +1-10-20 degrees.

4. The steering assist system of claim 1, wherein at the first mode when the vehicle is placed in an operational position for motion in a rearward direction, the one or more first sensors are utilized to detect objects in the first zone and not in the second zone, the first zone being an area behind the vehicle, and wherein at a third mode when the vehicle is placed in an operational position for motion in a forward direction, the one or more first sensors are utilized to detect objects in the first zone and not in the second zone, the first zone being an area in front of the vehicle.

5. The steering assist system of claim 2, further comprising one or more second sensors that scan a second area, the second area includes at least a portion of a third zone and at least a portion of a forth zone, the third zone being either behind or in front of the vehicle and extending substantially the width of the vehicle, the forth zone adjacent the third zone, the forth zone extending along a second side of the vehicle and extending in an outward vehicle lengthwise direction from a corner of the vehicle.

6. The steering assist system of claim 5, wherein at the second mode when the vehicle is placed in an operational position for motion in a rearward direction, the first zone being an area behind the vehicle and the third zone being an area in front of the vehicle, at least one of the second sensors is utilized to detect objects in the forth zone.

7. The steering assist system of claim 5, wherein at the second mode when the vehicle is placed in an operational position for motion in a forward direction, the first zone being an area in front of the vehicle and the third zone being an area behind of the vehicle, at least one of the second sensors is utilized to detect objects in the forth zone.

8. The steering assist system of claim 5, wherein at the first or third modes the system does not generate a signal to notify the vehicle operator of objects detected in the forth zone.

9. The steering assist system of claim 1, wherein the system is configured to generate a signal to notify a vehicle operator of detection of an object.

10. The steering assist system of claim 1, wherein the system is configured to detect objects automatically at vehicle speeds below or equal to a predetermined threshold.

11. A method for operating a steering assist system for a vehicle comprising:
detecting an angular position of a steering wheel, utilizing a steering angle sensor;
scanning a first area for objects utilizing one or more first sensors, the first area includes at least a portion of a first zone and at least a portion of a second zone, the first zone behind or in front of the vehicle and extending substantially the width of the vehicle, the second zone adjacent to the first zone, the second zone extending along a first side of the vehicle and extending in an outward vehicle lengthwise direction from a corner of the vehicle; and
switching between a first mode and a second mode based on the angular position of the steering wheel utilizing a control module, wherein at the first mode the one or more first sensors are utilized to detect objects in at least the portion of the first zone and not in the second zone, and wherein at the second mode at least one of the one or more first sensors is utilized to detect objects in the first area.

12. The method of claim 11, further comprising switching from the first mode to the second mode when the angular position of the steering wheel is greater than a predetermined threshold.

13. The method of claim 12, wherein the predetermined threshold is one of +1-5 degrees, +1-10 degrees, +1-10-20 degrees.

14. The method of claim 11, wherein at the first mode when the vehicle is placed in an operational position for motion in a rearward direction, the one or more first sensors are utilized to detect objects in the first zone and not in the second zone, the first zone being an area behind the vehicle, and wherein at a third mode when the vehicle is placed in an operational position for motion in a forward direction, the one or more first sensors are utilized to detect objects in the first zone and not in the second zone, the first zone being an area in front of the vehicle.

15. The method of claim 12, further comprising one or more second sensors that scan a second area, the second area includes at least a portion of a third zone and at least a portion of a forth zone, the third zone being either behind or in front of the vehicle and extending substantially the width of the vehicle, the forth zone adjacent the third zone, the forth zone extending along a second side of the vehicle and extending in an outward vehicle lengthwise direction from a corner of the vehicle.

16. The method of claim 15, wherein at the second mode when the vehicle is placed in an operational position for motion in a rearward direction, the first zone being an area behind the vehicle and the third zone being an area in front of the vehicle, at least one of the second sensors is utilized to detect objects in the forth zone.

17. The method of claim 15, wherein at the second mode when the vehicle is placed in an operational position for motion in a forward direction, the first zone being an area in front of the vehicle and the third zone being an area behind of the vehicle, at least one of the second sensors is utilized to detect objects in the forth zone.

18. The method of claim 15, wherein at the first or third modes the system does not generate a signal to notify the vehicle operator of objects detected in the forth zone.

19. The method of claim 11, further comprising, generating a signal to notify a vehicle operator of detection of an object.

20. The method of claim 11, wherein the system is configured to detect objects automatically at vehicle speeds below or equal to a predetermined threshold.
